(19) United States
(12) Patent Application Publication
(10) Pub. No.: US 2022/0101336 A1
(43) Pub. Date: Mar. 31, 2022

(54) COMPLIANT AND AUDITABLE DATA HANDLING IN A DATA CONFIDENCE FABRIC

(71) Applicant: EMC IP Holding Company LLC, Hopkinton, MA (US)

(72) Inventor: Stephen J. Todd, North Andover, MA (US)

(21) Appl. No.: 17/038,840

(22) Filed: Sep. 30, 2020

(51) Int. Cl. G06Q 30/00; G06F 16/23

(52) U.S. Cl. CPC G06Q 30/018; G06F 16/2379

(57) ABSTRACT

One example method includes receiving, at an entity, a stream of data and associated trust metadata, inspecting, by the entity, the trust metadata to identify a policy annotation, when the entity is capable of doing so, processing, by the entity, the stream of data according to requirements of the policy annotation, and annotating, by the entity, the processed data with an annotation to indicate that the data was processed in accordance with the requirements of the policy annotation.

### FIELD OF THE INVENTION

Embodiments of the present invention generally relate to the handling of data in complex network environments. More particularly, at least some embodiments of the invention relate to systems, hardware, software, computer-readable media, and methods for creating and using a data confidence fabric which may enable compliance and auditability in the handling of network data.

### BACKGROUND

The size and complexity of computer networks is ever-increasing, and such complexity and growth continue to introduce new challenges. One area of particular concern is compliance. That is, it can be difficult, if not impossible, to ensure that data created in and/or transiting a network is being handled in a manner that is compliant with applicable statutes, rules, and regulations. Another area of concern is auditability. Enterprises and other entities may want to be able to perform audits to determine how data is being handling in their network. However, complex computing environments make it difficult to perform audits of data handling processes, and other related processes.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 illustrates an example of the complex routing of data.

FIG. 2 illustrates an example of data stream variety in an edge ecosystem.

FIG. 3 illustrates data stream variety in one example environment.

FIG. 4 illustrates the complexity of regulatory mapping.

FIG. 5 discloses aspects of an example DCF annotation and scoring framework.

FIG. 6 discloses aspects of device-level policy annotation in a DCF.

FIG. 7 discloses an example of a gateway attaching policy annotation on behalf of device.

FIG. 8 discloses an example of processing policy annotations before data.

FIG. 9 discloses aspects of an example method for parsing and executing policy annotations.

FIG. 10 discloses aspects of an example computing entity.

### DETAILED DESCRIPTION OF SOME EXAMPLE EMBODIMENTS

Embodiments of the present invention generally relate to the handling of data in complex network environments. More particularly, at least some embodiments of the invention relate to systems, hardware, software, computer-readable media, and methods for creating and using a data confidence fabric which may enable compliance and auditability in the handling of network data.

In one example embodiment, a data confidence fabric (DCF) is provided that may include various features that may be employed to enable compliance and auditability in the handling of data. In general, the DCF may be equipped to annotate data generated by one or more devices, and to perform other processes concerning the data, as the data transits the DCF.

One such feature of an example DCF is the ability for a data generating device, such as a sensor for example, to annotate that data with one or more policies that govern the handling of the data as it transits the DCF. In some embodiments, additional devices, and/or alternative devices, may perform the annotation. In any case, the annotations may be inspected, such as before processing is performed by a device or devices, by processing logic as the data transits the DCF. In this way, assurance may be had that the data transiting the DCF is being handled, or processed, according to any applicable policies. As well, metadata generated in connection with the processing of the data may be logged, and the combination of the DCF annotations and logs may form an auditable body of evidence demonstrating compliance with applicable policies.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that DCF data may be processed in a manner that is consistent with applicable policies. In one embodiment, metadata may be generated as a result of processing of data, and the metadata may be logged to enable a subsequent audit process. In one embodiment, annotations applied to DCF data, combined with logged metadata, may form an auditable body of data which may be used to determine whether the DCF data was handled as required by applicable policies.

### A. Overview

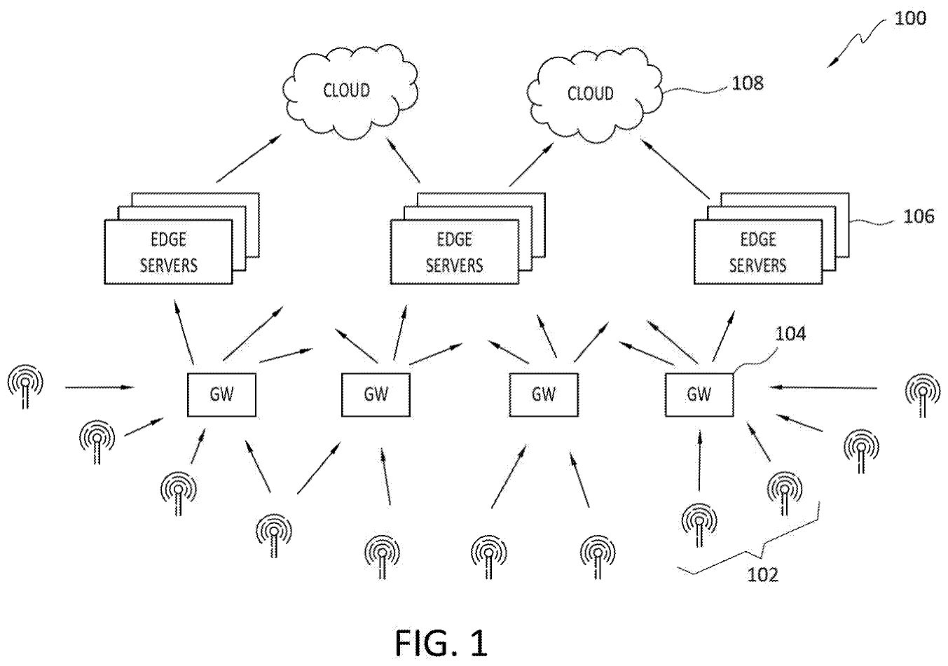

With reference now to FIG. 1, one or more embodiments of the invention may be employed in connection with a network 100 that may include various systems, devices, hardware, and software. In general, the network 100 may comprise a mesh of data flows in which a cascade of data flows from multiple sensors across gateways, edge servers, and into the cloud, as discussed below.

In particular, the example network 100 may include one or more data generators, such as sensors 102 for example, that may communicate with one or more gateways 104. Each of the gateways 104 may, in turn, communicate with one or more edge servers 106. The edge servers 106 may communicate with one or more cloud sites 108. Thus, the example network 100 has a multi-tiered structure in which data generated by devices, such as sensors 102 flows upward (from the perspective of FIG. 1) through various tiers or levels until the data reaches one or more cloud sites 108, at which one or more applications may evaluate and use the data.

Note that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

In the example implementation of the network 100, where one or more data generators take the form of a sensor 102, the sensors may be operable to detect and report on atmospheric conditions within a particular volume, such as a volume defined by a building that houses a datacenter for example, and sensors operable to detect and report on operational parameters concerning the status and operation of computing systems, hardware, software, and devices. As used herein, ‘atmospheric conditions’ refer to conditions, examples of which are set forth below, within such a volume, or other volume. Atmospheric conditions are not specific to any particular computing system, hardware, software, or device, but rather concern the physical environment in which a computing system, hardware, software, or device, operates. On the other hand, ‘operational conditions’ refer to conditions associated with operation of a particular computing device, system, hardware, and/or software.

Note that as used herein, a ‘sensor’ is broad in scope and may embrace, but is not limited to, any device, system, hardware, and/or software, operable to detect and report atmospheric conditions including, but not limited to, light, heat, moisture, temperature, pressure, humidity, smoke, gases, sound, vibration, motion. Thus, such atmospheric conditions include physical conditions in a physical environment, such as a datacenter building for example, in which a computing system, device, hardware, and/or software may operate. The term ‘sensor’ also may embrace, but is not limited to, any device, system, and/or software, operable to detect and report operational conditions of any type of computing device, system, or component, where such operational conditions may include, but are not limited to, bandwidth, computing device temperature, throughput rate, disk operation, disk RPMs, and bit error rate.

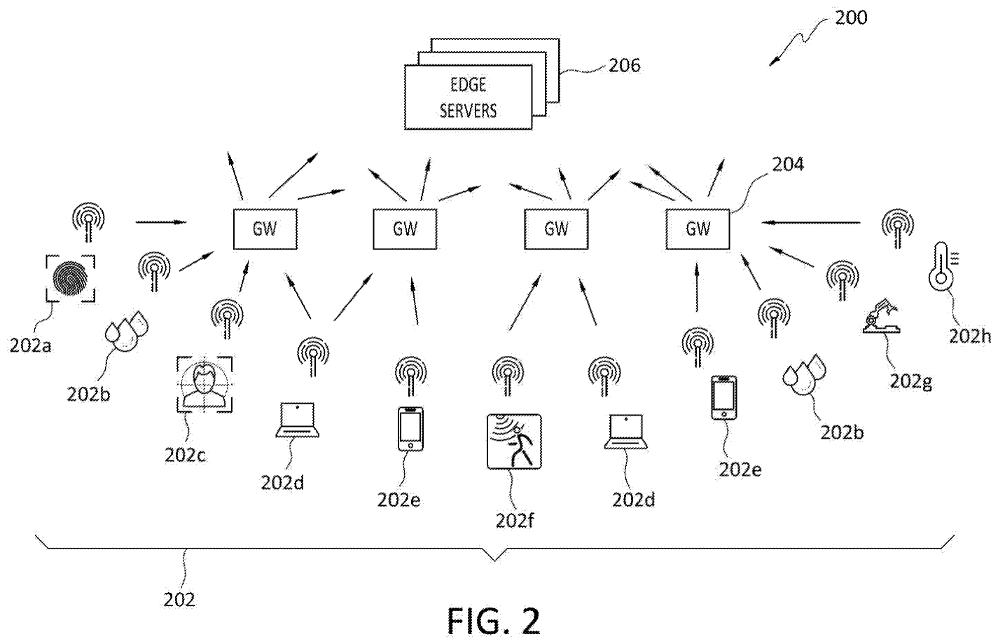

With continued reference to the example network 100 of FIG. 1, attention is directed, for example, to the edge servers 106. When sensor 102 data arrives at the edge server 106, that data may, in theory at least, have been generated by any of the ten or more sensors 102 generating data. Thus, it may be difficult, in this example, for the edge server 106 to be certain that its handling of the sensor 102 data is compliant, for example, with corporate, regional, or national regulations. As discussed in further detail below in connection with FIG. 2, such uncertainty may present a barrier to compliance assurance, and to creation of an auditable body of evidence that can be used to verify compliance.

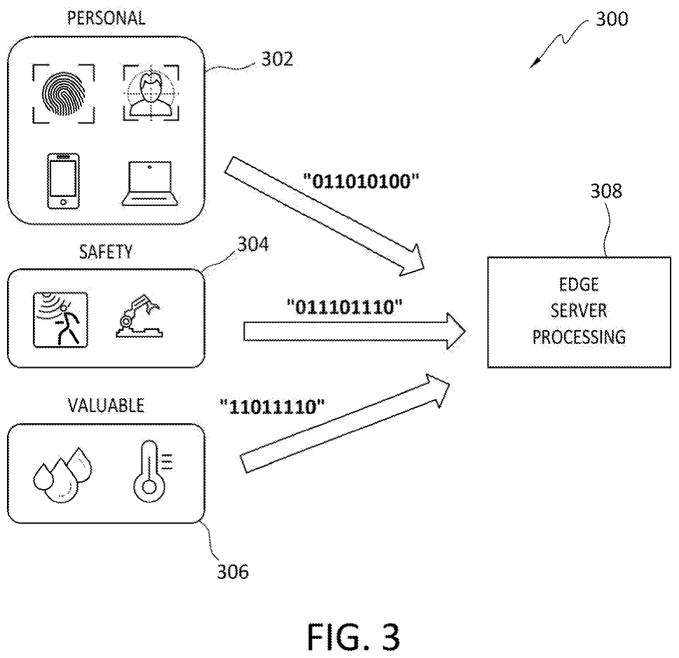

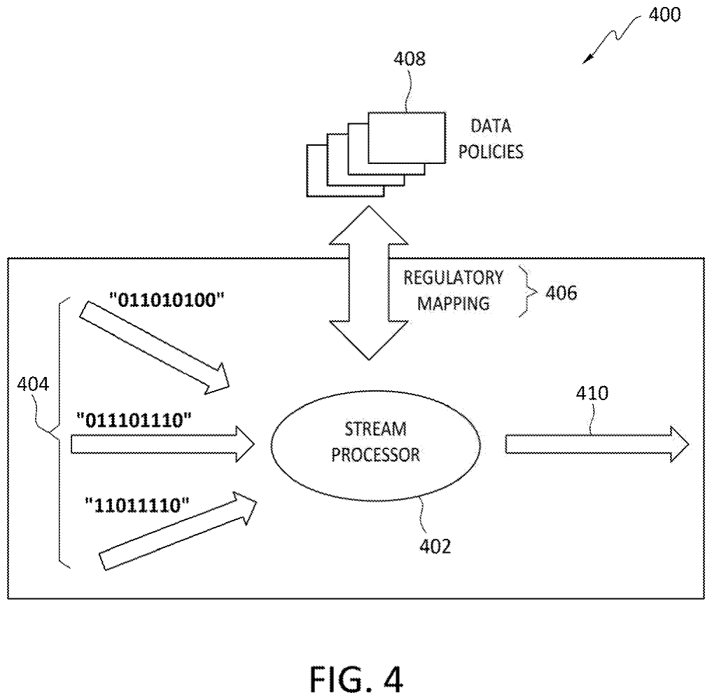

The example configuration 200 of FIG. 2 may comprise a variety of data generators 202 that may generate data and transmit that data to one more gateways 204, which may then pass the data to one or more edge servers 206. Because each of the data generators 202 may be different, there may be a large volume, and variety, of data ultimately received by the edge servers 206. In a manufacturing environment, for example, the data generators 202, which may each generate respective data, may comprise any one or more of: a fingerprint scanner 202a that scans fingerprints as employees access restricted areas; a humidity sensor 202b on a manufacturing floor; facial recognition software 202c that performs scans as employees and visitors arrive in the lobby; employee laptops or tablets 202d in use throughout a manufacturing building; cell phones 202e emit GPS locations or other data streams; motion detectors 202f that track employee movement in dangerous environments; robot arms 202g of manufacturing machines; and, temperature sensors 202h deployed throughout a building. Handling this variety, and volume, of data may be difficult, as explained below with reference to FIGS. 3 and 4.

With regard first to the configuration 300 of FIG. 3, it can be seen that each of a variety of different data generator types, such as those disclosed in FIG. 2 for example, has been assigned to a more general category, such as ‘Personal’ 302, ‘Safety’ 304, and ‘Valuable’ 306. Each category may be associated with a different respective classification in terms of the respective corporate, national, or international regulations that may apply to each of those categories.

Thus, as indicated in the example of FIG. 3, and edge server 308 in a manufacturing context such as the example disclosed in FIG. 2, may have to handle various different types of data streams. Such data streams may include, for example, ‘Personal’ 302 category data streams with a personal focus, such as user-related or consumer-related data streams coming from facial recognition software, employee devices and cell phones, and biometric scanners. When these data streams arrive at an edge server 308, or any other type of processor, there may be a large number of regulations, such as GDPR (European Union General Data Protection Regulation) and CCPA (California Consumer Privacy Act) for example, that may govern how that edge server 308 processes the data. Another type of data stream that may be received by the edge server 308 may be ‘Safety’ 304 category data streams such as may be received from manufacturing environments, including data generated by video monitors, motion detectors, and outputs from robot arms that are involved in a manufacturing process. These data may require critical processing, such as immediate shutdown of a robot arm for example, and/or may be involved in subsequent forensic examination in the case of a lawsuit. As a further example, a ‘Valuable’ 306 category data stream transmitted to the edger server 308 may include data collected from the environment that could be publicly sold, such as data gathered by temperature and humidity sensors in a building or region. This data may require special treatment to receive the most value in a data sale. As these examples, illustrate, each of the data streams received, such as by an edge server, may require different respective handling processes.

With reference now to the example scheme 400 of FIG. 4, details are provided concerning some regulatory mapping issues that can arise in environments such as those disclosed in FIGS. 1-2, when attempting to process data streams such as the examples disclosed in FIG. 3. In particular, a stream processor 402, such as an edge server for example, may receive a wide variety of data 404 types and the stream processor 402 may have to perform a regulatory mapping process 406 to figure out how to handle the data 404 of the data streams. The regulatory mapping process 406 may be made more complex by the number, and location, of the policies 408 that govern the handling of the data 404 by the stream processor 402.

FIG. 4 illustrates other problems as well that could arise in contexts such as the example environments of FIGS. 1 and 2. Such problems generally concern point-of-processing audit logs. As disclosed in FIG. 4, the stream processor 402 may have to make a decision about processing the data 404, and the stream processor 402 may then generate and transmit some sort of output 410 that indicates what processing was performed on the data 404. The context of how the stream processor 402 decided to handle the data 404 may, or may not, have been logged. However, even if that context information and decision have been logged, the location of the corresponding log entry is may be separate from the output, making it difficult to make a future forensic correlation between the data 404 and the processes performed on the data 404 by the stream processor 402.

Further, the stream processor 402 in FIG. 4 may reach the conclusion that it should not process the data 404 in a particular way, or at all, because doing so would violate a policy 408. Or, the stream processor 402 may decide that while it cannot process the data 404, the stream processor 402 should forward the data 404. In some cases, it may be important for the stream processor to log the fact that the stream processor 402 did not look at the data 404. It also may be important to record why the stream processor 402 did not look at the data. For example, it might have been a violation of a policy 408 for the stream processor 402 to look at the data 404. The decision by the stream processor 402 not to look at the data 404 may, or may not, have been logged, and even if that decision were logged, it may difficult to correlate this log entry with the original data 404 stream.

Finally, the scheme 400 indicated in FIG. 4 may give rise to problems such as inadequate processing. Particularly, the stream processor 402 may not recognize what type of data it is receiving, and therefore the stream processor 402 may miss an opportunity to process the data in a way that benefits the business. For example, if the data 404 is ‘Valuable’ category data, such as temperature or humidity data for example that may bring revenue in the form of a data sale, there may be an opportunity to enrich that data 404 to make it relatively more valuable, such as by associating provenance metadata or other business context with the data 404.

### B. Aspects of Some Example Embodiments

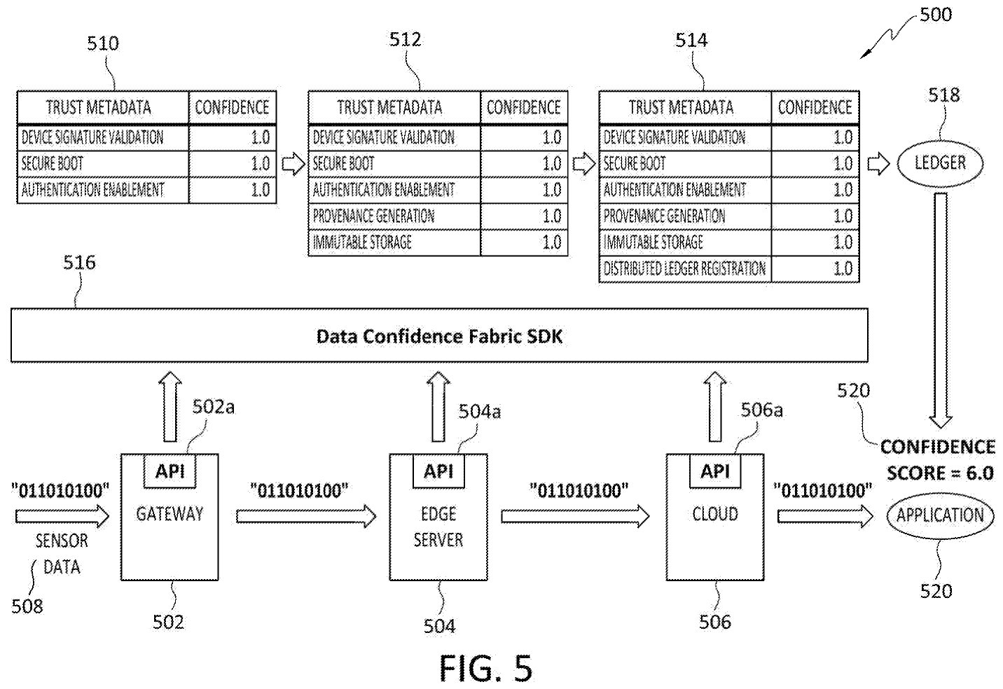

Various aspects of example embodiments have been addressed previously herein and, directing attention now to FIG. 5, still further aspects of some example embodiments are disclosed. In general, embodiments of the invention may resolve one or more of the concerns disclosed herein through the use of data confidence fabrics (DCFs). A DCF may be used for the purpose of “scoring” or “ranking” data as the data transits the various levels or tiers of the DCF, and the DCF may also implement functionality that enables compliance with data handling policies, and provides for auditability of actions taken with respect to the data. FIG. 5 provides an overview of one example of a DCF.

In FIG. 5, the example DCF is denoted generally at 500. The DCF 500 may include various systems, devices, hardware, and software, which may be referred to as nodes, at different levels of the DCF 500. For example, the DCF 500 may include a gateway 502, edge server 504, and cloud site 506, each of which may annotate data 508 with respective trust metadata 510, 512, and 514, as the data 508 transits the DCF 500. This annotation may take place through the use of respective APIs 502a, 504a, and 506a, that communicate with a DCF SDK (software development kit) 516 to access trust metadata annotated to the data 508 by one or more upstream nodes. The aggregate trust metadata 514 may be stored in a ledger 518 that generates an overall confidence score 520 for the data 508, and which is accessible, such as by an application 520 for example. By accessing the ledger 518, the application 520 may be able to determine a confidence score associated with data that the application 520 needs to access and use.

With further reference to annotation, in the example of FIG. 4, the gateway 502 may annotate and score a stream of data 508 as the stream passes through the gate 502. The edge server 504 and/or the cloud site 506 may perform similar processes. In the particular case of the gateway 502, the gateway may annotate and score the facts that the gateway 502 was able to validate a signature on the data 508 coming from a data generator (not shown), the fact that the gateway 502 underwent a secure boot process, and the fact that the gateway 502 is running authentication software that does not permit an entity to inspect the data 508 stream without permission. By annotating the data 508 with the trust metadata 510 concerning the aforementioned items, the gateway 502 may essentially vouch for the credibility, or trustworthiness, of the data 508, at least as to the aspects that the gateway 502 is equipped and able to evaluate.

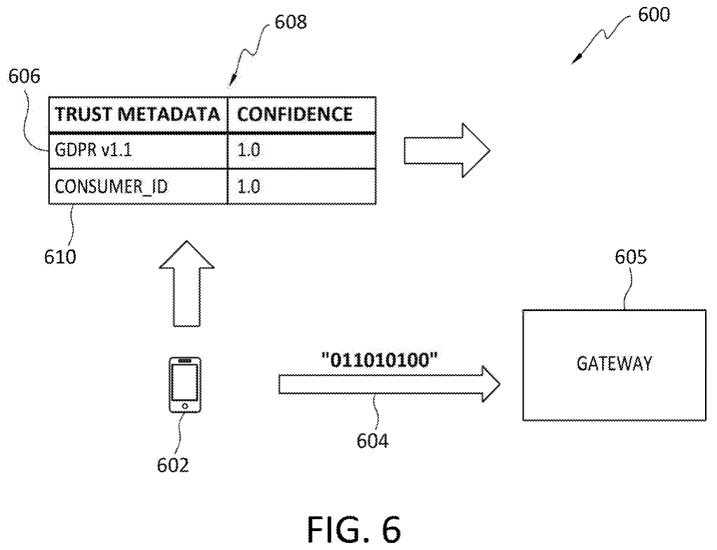

With the example DCF 500 of FIG. 5 in view, attention is directed next to FIG. 6, a scheme 600 is disclosed for device-level policy annotation in a DCF. In this example device-level approach to policy annotation, a device 602 may immediately annotate new, that is, fresh outgoing data 604 with one or more relevant policies 606 that specify how the data 604 should be handled as the data 604 transits the DCF to another node, such as a gateway 605 for example.

Unless otherwise specified by the device 602, the policy 606 that is annotated to the data 604 may control handling of the data 604 at all downstream nodes. In other embodiments, a policy 606 may specify, for example, that the data 604 is to be handled in a particular way, but only between the device 602 and a particular group of one or more downstream nodes, after which, the policy 606 may no longer apply and may not be enforced. For example, a policy 606 may specify that data should be handled a particular way between node A and downstream node B, but after the data has passed through node B, the policy no longer applies and is not enforce. In another example, a policy 606 may specify that data will be handled a particular way between nodes A and B, and between nodes C and D, but does not control the handling of the data between nodes B and C. In a further example, a policy 606 may specify that data is to be handled a particular way from node A to node ‘n,’ where ‘n’ is any positive integer. Any of the foregoing examples may be combined to define yet further ways that a policy may dictate the handling of data between/among nodes.

With continued reference now to FIG. 6, as the device 602, which may be a cell phone for example, generates data 604, the device 602 may also create a DCF annotation 608, which may comprise trust metadata and associated confidence scores, that highlights information relevant to the data policy 606 which governs the handling of the data 604. Annotations 608 made to data by a node of a DCF may take various different forms. In the example of FIG. 6, the device 602 describes a GDPR version as a policy 606, and the applicability of the GDPR to the data 604 is reflected in the DCF annotation 608. A policy 606 may also comprise a URL or object-ID that describes the policy that is being applied to the handling of the data 604. In addition, the device 602 may also elect to publish the user name 610, or some other form of identity, associated with the device 602 data 604.

In some instances, a particular device may not be capable, for one reason or another, of annotating policy information to data received and/or generated by the device. In such circumstances, a ‘next-level’ policy annotation approach may be employed.

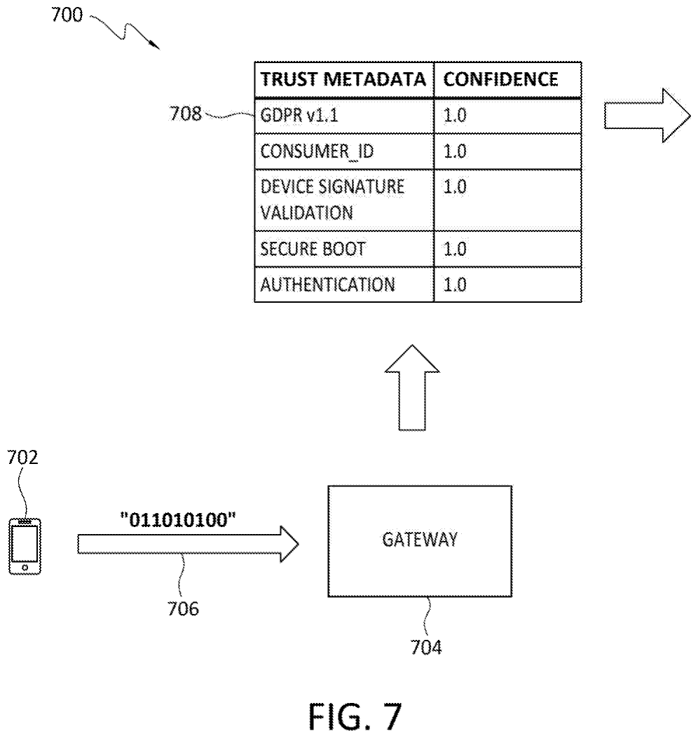

Particularly, and with reference now to the example scheme 700 in FIG. 7, when a device 702 is not capable of performing a policy annotation, for whatever reason, the device at the next level, that is a device downstream of the incapable device, may choose to perform the annotation. To implement such an approach, the downstream device, which may be a gateway 704 for example, may need to be aware that certain devices, or groups of devices, map to certain policies. That is, for example, the gateway 704 may need to be aware of the policies that the device 702 would annotate to the data 706 if the device 702 were capable of doing so. In some instances, the device 702, and/or an administrator, may notify the gateway 704 that the device 702 cannot perform the necessary annotation, and the device 702 and/or the administrator, may provide the gateway 704 with the annotation information that the device 702 would ordinarily have applied to the data 706.

Similarly, the downstream device, such as the gateway 704, may or may not have all of the context, such as identity of the data owner or user, concerning the data that is to be annotated and, as such, this context information may be obtained by the gateway 704 from the device 702, or other source. Note that with ‘next level’ policy annotation approach, the gateway 704, for example, may continue with its normal annotations, such as ‘secure boot,’ but upstream processing logic may now also contain a statement about the policy 708 for example, or policies, that apply to the data 706 stream and that were to have been annotated to the data 706 by the device 702 until responsibility for that policy annotation passed to the gateway 704 instead.

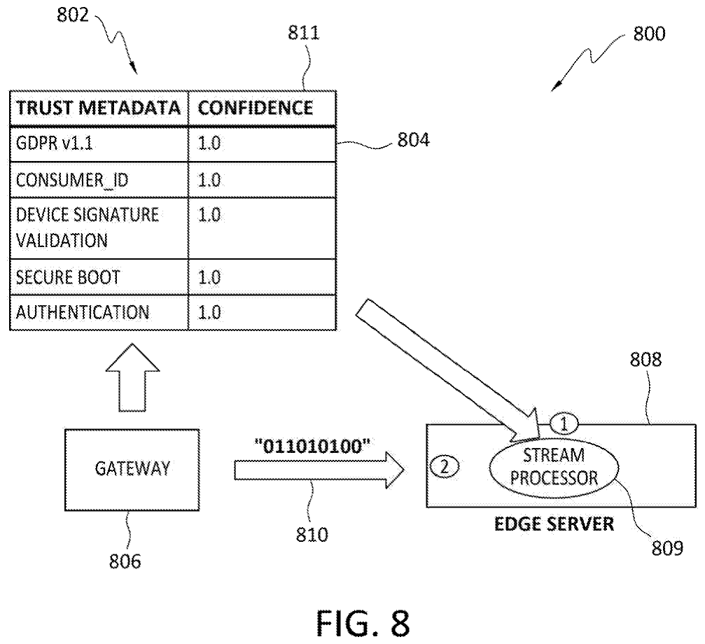

In some embodiments, policy annotations that are expected to be applied to data may be inspected prior to the processing of the data in the manner specified in the policies. In particular, and with reference now to FIG. 8, an example scheme 800 is disclosed in which, as the DCF metadata 802, including policy annotations 804, flow downstream (1) to an edge server 808, stream processing logic 809, which may reside in the edge server 808 for example, may inspect those policy annotations before the edge server 808 attempts to process, in accordance with the policies, the data 810 received (2) from the gateway 806. Thus, in some embodiments, the handling of data, such as the data 810 for example, may comprise a two part process.

Particularly, the handling of the data 810 may include a first part in which, for example, the stream processor 809 has access to the DCF metadata 802 and can inspect the trust metadata to determine if there are any policy 804 annotations. Next, and depending on the type of policy 804 or policies involved, the stream processor 809 may then accept the data 810 stream and attempt to process the data 810 in a manner that is compliant with the policy 804 or policies that have been applied to the data 810.

This latter process may involve the introduction and use of business logic for parsing and executing policy 804 annotations to the data 810. For example, when processing policy annotations upstream, that is, the stream processor 809 of the edge server 808 is downstream of the gateway 806, stream processors 809 may perform different business logic that handles or processes the data 810 in different respective ways. For example, in FIG. 8, the data 810 may be processed by the stream processor 809 in a way that is consistent with the data handling guidelines set forth in the GDPR, and a confidence score of 1.0 applied to the policy 804, reflecting and confirming that the data 810 was properly handled as specified by the policy 804.

The aforementioned parsing process may include identifying respective confidence scores 811 associated with one or more policies 804. The confidence scores 811 may be reported, such as to an auditor, administrator, and/or other entities, and the use and/or reporting of the confidence scores 811 may be leveraged in various ways. For example, increases or decreases in confidence scores 811 associated with a policy 804 may trigger a modification to an existing data protection policy. As another example, an increase in a confidence score 811 associated with a policy 804 may attract applications in search of more trustworthy data, that is, data with confidence scores higher than the confidence scores associated with data currently being utilized by the applications.

### D. Example Methods

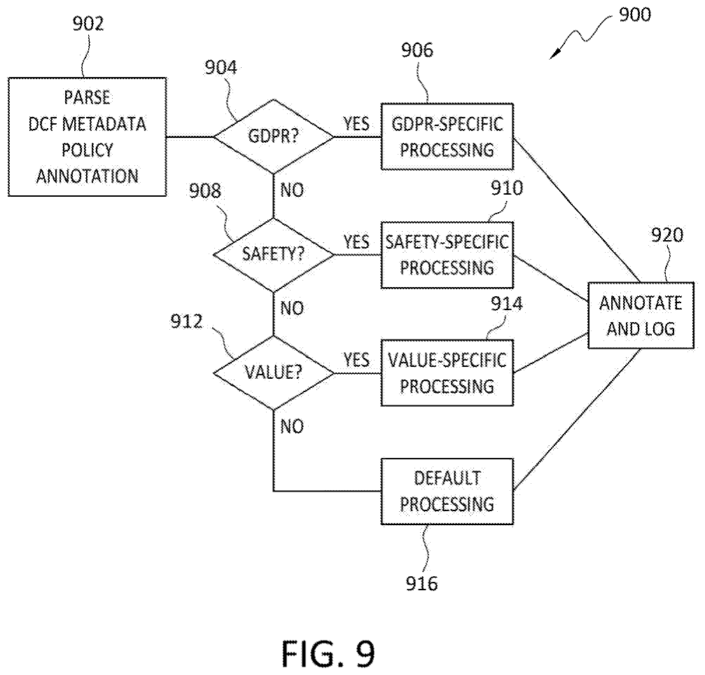

It is noted with respect to the example method of FIG. 9 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Directing attention now to FIG. 9, aspects of example methods for inspection of policy annotations are disclosed, one example of which is denoted generally at 900. In general, policy annotations may be inspected in order that an entity, such as an edge server for example, may become aware of how to process data received by that entity. That is, the inspection may reveal one or more policies that govern handling of the data by the entity.

By way of example, an entity that identifies, in a policy annotation, a GDPR-specific policy, may also look at additional consumer data, and decide whether or not to process the stream, or to take some other measures that are specific to GDPR compliance. If the inspecting entity does not recognize the policy, or if there is no policy present, a default processing handler may be invoked. In at least some embodiments, the entity that processes the data according to the policy, or another entity, may annotate the data to indicate that such processing has been performed, and may log the annotations, such as in a ledger. For example, the execution of policy annotations may cause the generation of additional annotations that may serve as proof that all policies were complied with in the processing of the data by the entity. These additional annotations may be added to the DCF metadata and data flow down-stream.

Additional metadata related to this processing may also be logged locally at the entity that performed the data processing. Thus, if a subsequent audit is performed, the DCF annotation and logs form a strong body of evidence that the data was handled in a manner compliant with the policies that applied to the data at the time the data was processed. Finally, in some embodiments, the DCF trust metadata may also include information about stream execution that occurred as a result of unknown or missing policies. These annotations may serve to inform an enterprise that it may be at risk due, for example, to execution of unknown policies with respect to the data in the DCF. The data affected by execution of unknown policies may be identified by searching the DCF metadata and taking corresponding actions, such as modifying or deleting the offending policy.

With particular reference now to FIG. 9, the method 900 may begin when an entity, such as a gateway or edge server for example, parses 902 DCF metadata and policy annotations concerning a stream of data received by the entity. As disclosed herein, a node from which the entity received the data stream may have annotated the data with one or more policy annotations. The process 902 may also be referred to as an inspection process, since the entity is inspecting the DCF metadata and policy annotations to identify any policies that may control the processing of the data by the entity. If the inspection process 902 should reveal 904 a GDPR policy for example, in the policy annotations, the method 900 may proceed to 906 where the entity processes the data in accordance with GDPR requirements.

If the inspection 902 does not reveal 904 a GDPR policy, the method 900 may proceed to determine 908 whether the policy annotations include any policy annotations concerning safety. If so, the method may proceed to 910 where the entity processes the data in accordance with the safety policies. On the other hand, if the inspection 902 does not reveal 908 a safety policy, the method 900 may proceed to 912 to determine whether or not the policy annotations include any policies concerning the relative value of the data. If so, the method may proceed to 914 where the entity processes the data in accordance with the value policies.

Whether any policies are identified at 904, 908, and/or 912, the method 900 may implement default processing 916 on the data. Default processing 916 may concerning any other processing of the data, such as ensuring the security of the data by encryption, for example.

As further indicated in FIG. 9, any data processing, such as 906, 910, 914, and/or 916, may be followed by an annotation and logging process 920. The annotation may include annotating the data to indicate that the data was processed by the entity in the manner specified by the applicable policies. As well, this annotation of the data may be logged in a ledger, or other appropriate mechanism.

With continued reference to FIG. 9, some additional considerations are noted. For example, policies may, or may not, be mutually exclusive. In the example of FIG. 9, it may be the case that if one policy is present, another policy is excluded, such that the data may be processed as required by the first policy, but may not be processed in accordance with the second policy. In other cases, two or more policies are not mutually exclusive, and data may be processed by the entity, or entities, according to multiple policies, such as both GDPR and safety policies.

Finally, an inspection 902 may, but need not, look for policies in serial fashion, one after the other, as shown in FIG. 09. In some embodiments, the inspection 902 may look for, and identify, multiple policies in parallel.

### E. Further Example Embodiments

Following are some further example embodiments of the invention. These are presented only by way of example and are not intended to limit the scope of the invention in any way.

Embodiment 1. A method, comprising: receiving, at an entity, a stream of data and associated trust metadata; inspecting, by the entity, the trust metadata to identify a policy annotation; when the entity is capable of doing so, processing, by the entity, the stream of data according to requirements of the policy annotation; and annotating, by the entity, the processed data with an annotation to indicate that the data was processed in accordance with the requirements of the policy annotation.

Embodiment 2. The method as recited in embodiment 1, further comprising logging the annotation in a log in association with the entity and the stream of data.

Embodiment 3. The method as recited in any of embodiments 1-2, wherein when the entity is incapable of processing the stream of data, the entity passes the stream of data and the policy annotation to another entity.

Embodiment 4. The method as recited in any of embodiments 1-3, wherein the trust metadata includes a confidence score that corresponds to the policy annotation.

Embodiment 5. The method as recited in any of embodiments 1-4, further comprising receiving multiple additional data streams, and respective trust metadata, at the entity, each of the data streams having been generated by a different respective data generator, and processing each of the multiple data streams according to respective policy annotations of those multiple data streams.

Embodiment 6. The method as recited in any of embodiments 1-5, wherein the entity is a node of a data confidence fabric.

Embodiment 7. The method as recited in any of embodiments 1-6, wherein the policy annotation was annotated to the stream of data by a data generator that generated the stream of data, and the stream of data is received by the entity from the data generator.

Embodiment 8. The method as recited in any of embodiments 1-7, wherein the policy annotation was annotated to the stream of data by a data generator other than a data generator that generated the stream of data.

Embodiment 9. The method as recited in any of embodiments 1-8, wherein the stream of data is processed in accordance with multiple different policies.

Embodiment 10. The method as recited in any of embodiments 1-9, wherein annotating the processed data with an annotation comprises adding the annotation, and an associated confidence score, to the trust metadata.

Embodiment 11. A method for performing any of the operations, methods, or processes, or any portion of any of these, disclosed herein.

Embodiment 12. A non-transitory storage medium having stored therein instructions that are executable by one or more hardware processors to perform the operations of any one or more of embodiments 1 through 11.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

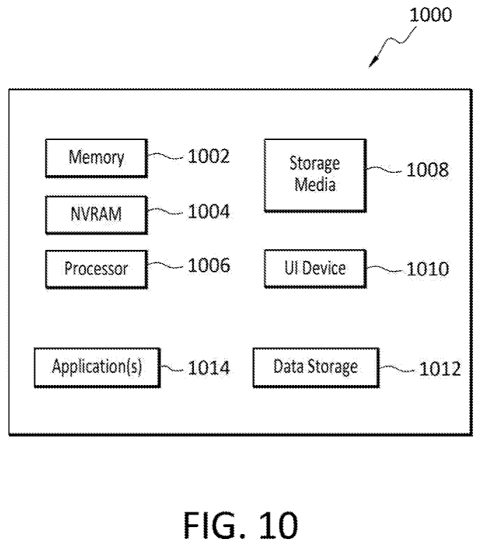

With reference briefly now to FIG. 10, any one or more of the entities disclosed, or implied, by FIGS. 1-9 and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, at an entity, a stream of data and associated trust metadata;
inspecting, by the entity, the trust metadata to identify a policy annotation;
when the entity is capable of doing so, processing, by the entity, the stream of data according to requirements of the policy annotation; and
annotating, by the entity, the processed data with an annotation to indicate that the data was processed in accordance with the requirements of the policy annotation.

2. The method as recited in claim 1, further comprising logging the annotation in a log in association with the entity and the stream of data.

3. The method as recited in claim 1, wherein when the entity is incapable of processing the stream of data, the entity passes the stream of data and the policy annotation to another entity.

4. The method as recited in claim 1, wherein the trust metadata includes a confidence score that corresponds to the policy annotation.

5. The method as recited in claim 1, further comprising receiving multiple additional data streams, and respective trust metadata, at the entity, each of the data streams having been generated by a different respective data generator, and processing each of the multiple data streams according to respective policy annotations of those multiple data streams.

6. The method as recited in claim 1, wherein the entity is a node of a data confidence fabric.

7. The method as recited in claim 1, wherein the policy annotation was annotated to the stream of data by a data generator that generated the stream of data, and the stream of data is received by the entity from the data generator.

8. The method as recited in claim 1, wherein the policy annotation was annotated to the stream of data by a data generator other than a data generator that generated the stream of data.

9. The method as recited in claim 1, wherein the stream of data is processed in accordance with multiple different policies.

10. The method as recited in claim 1, wherein annotating the processed data with an annotation comprises adding the annotation, and an associated confidence score, to the trust metadata.

11. A non-transitory storage medium having stored therein instructions that are executable by one or more hardware processors to perform operations comprising:
receiving, at an entity, a stream of data and associated trust metadata;
inspecting, by the entity, the trust metadata to identify a policy annotation;
when the entity is capable of doing so, processing, by the entity, the stream of data according to requirements of the policy annotation; and
annotating, by the entity, the processed data with an annotation to indicate that the data was processed in accordance with the requirements of the policy annotation.

12. The non-transitory storage medium as recited in claim 11, wherein the operations further comprise logging the annotation in a log in association with the entity and the stream of data.

13. The non-transitory storage medium as recited in claim 11, wherein when the entity is incapable of processing the stream of data, the entity passes the stream of data and the policy annotation to another entity.

14. The non-transitory storage medium as recited in claim 11, wherein the trust metadata includes a confidence score that corresponds to the policy annotation.

15. The non-transitory storage medium as recited in claim 11, wherein the operations further comprise receiving multiple additional data streams, and respective trust metadata, at the entity, each of the data streams having been generated by a different respective data generator, and processing each of the multiple data streams according to respective policy annotations of those multiple data streams.

16. The non-transitory storage medium as recited in claim 11, wherein the entity is a node of a data confidence fabric.

17. The non-transitory storage medium as recited in claim 11, wherein the policy annotation was annotated to the stream of data by a data generator that generated the stream of data, and the stream of data is received by the entity from the data generator.

18. The non-transitory storage medium as recited in claim 11, wherein the policy annotation was annotated to the stream of data by a data generator other than a data generator that generated the stream of data.

19. The non-transitory storage medium as recited in claim 11, wherein the stream of data is processed in accordance with multiple different policies.

20. The non-transitory storage medium as recited in claim 11, wherein annotating the processed data with an annotation comprises adding the annotation, and an associated confidence score, to the trust metadata.
